(19) United States
(12) Patent Application Publication
(10) Pub. No.: US 2025/0042515 A1
(43) Pub. Date: Feb. 6, 2025

(54) AUTOMATIC SENSOR DEPLOYMENT SYSTEM

(71) Applicant: FNV IP B.V., Leidschendam (NL)

(72) Inventors: Michael Joseph COLE, Katy, TX (US); Mark STEVENS, Houston, TX (US)

(21) Appl. No.: 18/365,066

(22) Filed: Aug. 3, 2023

(51) Int. Cl. B63B 27/16; B63B 49/00

(52) U.S. Cl. CPC B63B 27/16; B63B 49/00

(57) ABSTRACT

An automatic sensor deployment system is provided for automatically deploying a sensor from a vessel to an underwater position. The automatic sensor deployment system comprises: a frame; a retractable arm supported by the frame, wherein a distal portion of the retractable arm is configured to be actuated from a retracted position to a deployed position in a direction away from the frame; a cable guide located at the distal portion of the retractable arm; a lifting cable supported by the cable guide; a sensor apparatus attached to the lifting cable, the sensor apparatus comprising a sensor for underwater sensing; a winch configured to retract and let out the lifting cable to raise and lower the sensor apparatus; and at least one actuator configured to actuate the retractable arm and the winch. Unlocking insights from Geo-Data, the present invention further relates to improvements in sustainability and environmental developments: together we create a safe and liveable world.

### FIELD

The present disclosure generally relates to the field of sensor deployment systems, and more specifically to systems and methods for deploying sensors from a vessel to an underwater position. Unlocking insights from Geo-Data, the present invention further relates to improvements in sustainability and environmental developments: together we create a safe and liveable world.

### BACKGROUND

Self-elevating vessels, commonly referred to as jack-up class vessels, jack-up barges, or jack-up rigs, are vessels that can transition between floating on a body of water and standing on legs contacting the seafloor. Such self-elevating vessels or jack-up vessels generally comprise a mobile platform that has a buoyant hull fitted with a number of movable legs, capable of raising its hull over the surface of the sea. The buoyant hull enables transportation of the unit and all attached machinery to a desired location. Once on location the hull is raised to the required elevation above the sea surface supported by the seabed. The legs of such units may be designed to penetrate the seabed, may be fitted with enlarged sections or footings, or may be attached to a bottom mat. The transition from floating to standing is performed by lowering legs to the seafloor and transferring the weight of the vessel onto the legs. Before a self-elevating vessel lowers its legs to the seafloor, a seafloor inspection is completed to ensure there are no hazards on or above the sea floor. Possible hazards include pipelines, electrical cables, debris, unexploded ordinances, impressions from prior structures standing on the seafloor, boulders, etc.

A method of detecting such hazards is to visualize the sea floor using an acoustic instrument, such as a scanning sonar instrument. The sonar instrument is deployed by manually lowering it to the seafloor over the edge of the vessel. This can be done by a crew member dropping the sonar instrument overboard or by the crew member attaching the sonar instrument to a crane and then operating the crane to lower the instrument overboard. In some cases, powered equipment such as an air-tugger can be used to assist the crew member in doing this.

Including an instrument onboard in order to measure the seafloor before lowering legs takes up valuable resources of the vessel, for example: storage space for storing the instrument; crane time spent lowering the instrument overboard; deck space that is unavailable while the instrument is lowered overboard; work time spent by the crew to operate equipment for lowering it overboard; work time spent by the crew for maintenance of the instrument and the equipment for lowering it overboard; etc. There is also an inherent risk to crew safety while manually handling the instrument and operating equipment for lowering the instrument overboard. The need for on-board personnel also requires a larger vessel, and transportation, often with helicopters to and from the vessel. These factors contribute to inefficiencies that either increase fuel consumption, and corresponding green-house gas emissions, of vessels, as well as longer operational times. There is also a relatively low degree of repeatability of such measurements due to variation in instrument deployment, e.g., due to constraints of different vessels, differences in lowering equipment or crew techniques, or the like. This increases the risk of accidental damage to the underwater environment and/or the vessel. Nevertheless, the need to avoid seafloor hazards when lowering legs is such that these factors have so far been compromised in order to perform measurements of the seafloor.

### SUMMARY

According to one aspect of the present disclosure, there is provided an automatic sensor deployment system for automatically deploying a sensor from a vessel to an underwater position. The automatic sensor deployment system comprises a frame and a retractable arm supported by the frame. A distal portion of the retractable arm is configured to be actuated from a retracted position to a deployed position in a direction away from the frame. The automatic sensor deployment system comprises a cable guide located at the distal portion of the retractable arm. The automatic sensor deployment system comprises a lifting cable supported by the cable guide. The term ‘supported’ refers to at least partial support of the lifting cable. That is, the lifting cable may run over or through the cable guide, which supports at least a part of the weight of the lifting cable and its payload. The automatic sensor deployment system comprises a sensor apparatus attached to the lifting cable. In an implementation, the sensor apparatus is attached to an end of the lifting cable. The sensor apparatus comprises a sensor for underwater sensing. The automatic sensor deployment system comprises a winch configured to retract and let out the lifting cable to raise and lower the sensor apparatus. The automatic sensor deployment system comprises at least one actuator configured to actuate the retractable arm and the winch.

An automatic sensor deployment system as described above, when mounted on a vessel, enables automated deployment of an underwater sensor from the vessel. The vessel may be any suitable type of marine vehicle including, but not limited to: a jack-up barge, which is a type of mobile platform that consists of a buoyant hull fitted with multiple movable legs; a survey vessel, which is often used for hydrographic research; or an autonomous vessel. Alternatively, the automatic sensor deployment system may be mounted on a platform on land adjacent a body of water or a platform surrounded by water but standing on legs under the water.

By virtue of the automatic sensor deployment system, enhanced operational safety and efficiency for seafloor inspections can be provided. By automating the deployment and recovery of the sensor system, human interaction is significantly reduced, mitigating safety risks associated with manual handling. Furthermore, the system provides for remote operation, introducing flexibility in operation and additional safety benefits.

The frame may be a housing that encloses the components of the system or may be a barebone structure such as a set of struts or a lone pillar, providing structural support to the components.

The distal portion of the retractable arm may be at or near a first end of the retractable arm, wherein a second end of the retractable arm, i.e. the end opposite to the first end, is attached to the frame. The actuation of the distal portion of the retractable arm may be linear motion, i.e., forwards and backwards in a single direction. Alternatively, the distal portion of the retractable arm may be arranged to be actuated in two or three directions, i.e. its position being variable in x, y, z coordinates.

The retractable arm may comprise one or more electric actuator of the at least one actuator, e.g., an electric rod actuator. Using electric actuators, as opposed to hydraulic actuators provides a system with less onerous maintenance requirements, due to fewer moving parts, no high-pressure hydraulic cylinders, and no risk of hydraulic fluid leaks. The actuator for the retractable arm may be performed by a servo motor, stepping motor, rotating motor with a mechanism to translate rotational motion into linear motion (such as using cams or using toothed gears with a linear ladder, or any other suitable mechanism), or any other suitable electro-mechanical actuator.

The cable guide may be a pulley. The pulley may be a wheel having a grooved rim, around which the lifting cable is passed, and having an axel of the wheel attached to the distal portion of the retractable arm. Alternatively, the cable guide may be an eyelet or other static guide and may comprise a low-friction material to reduce wear on the lifting cable. In a typical arrangement, the lifting cable travels from the winch to cable guide, through or over the cable guide, and is attached to the sensor apparatus on the side of the cable guide opposite the side facing the winch. In this arrangement the sensor apparatus will hang downwards under gravity, providing tension to the lifting cable such that the lifting cable is taut between the cable guide and the winch. The path of lifting cable between the cable guide and where the lifting cable is let out from the winch may be substantially horizontal with respect to the ground level or sea-level, or form an angle of less than 45 degrees with respect to a horizontal plane parallel to ground level or sea-level passing through the cable guide, optionally less than 40 degrees, less than 30 degrees, less than 20 degrees, or less than 10 degrees.

The sensor apparatus may be directly or indirectly attached to the lifting cable.

The sensor may be a scanning sonar, used for mapping the seafloor; a velocity sound profiler, utilized for measuring the speed of sound in water at various depths; a magnetometer, designed to measure magnetic anomalies in the earth's field; or a combination or two or more of the above, or any other sensor suitable for underwater sensing.

The winch may be an electronic winch, i.e., comprising an electronic actuator of the at least one actuator to retract and let out the lifting cable. The actuation of the winch may be by a rotational motor, optionally including one or more gears, or a mechanism to translate linear motion from a linear actuator into rotational motion. The actuation may be by driving a drum of the winch that stores the lifting cable by wrapping around the drum.

The at least one actuator may be two actuators, an arm actuator for actuating the retractable arm and a winch actuator. The at least one actuator may include a plurality of actuators, with an actuator for each moving (or otherwise actuatable) component of the automatic sensor deployment system. Alternatively, the at least one actuator may be a single actuator configured to control both the retractable arm and the winch. The at least one actuator may be electronic, e.g. an electronic arm actuator and an electronic winch actuator. The at least one actuator may be driven by one or more motor, e.g. by a single motor, or a respective motor for each component, e.g. an arm motor for the retractable arm and a winch motor for the winch. The at least one actuator and/or corresponding motor(s) may be controlled by electronic circuitry, e.g. one or more (individual or connected) electronic circuits. The at least one actuator, or electronic circuitry controlling at least one actuator, may receive instruction signal from a communication module and/or a processor to actuate the retractable arm and/or the winch. The at least one actuator may be integrated as part of the retractable arm and/or the winch, as may be any corresponding motor and or electronic circuitry.

The automatic sensor deployment system may comprise a power unit. The power unit may be a battery, or a connector for receiving electronic power from an external power source.

An actuator configured to actuate the retractable arm may be an electric rod actuator. An actuator configured to actuate the winch a may be a motor of the winch. Actuation of the automatic sensor deployment system may be entirely electric and mechanical, i.e. without any hydraulics.

The winch and the at least one actuator may be supported by the frame such that the automatic sensor deployment system can be lifted as a unit via the frame. That is, either or both component may be supported by the frame, directly or indirectly. This makes it easier to mount and dismount the automatic deployment system onto a vessel. The frame may comprise one or more lifting point, e.g., one or more eyelet or hook, which the entire system may be lifted by a crane or similar for loading and uploading to and from a vessel. The sensor deployment system may be no more than 1000 kilograms, optionally no more than 750 kilograms, 500 kilograms; 250 kilograms, or 100 kilograms. 1 kilogram is approximately 2.2 pounds. Designs such as the above facilitate a compact and cohesive unit that can be lifted and transported conveniently, enhancing the operational flexibility of the system. Conventional systems are heavy and cumbersome and cannot be readily moved around on, or on and off a vessel. As such, the operational flexibility of the present system is increased. Planning time may thus be decreased, and the system can be provided to vessels for shorter periodic instalments, leading to an improved efficiency of fleet management.

The frame may comprise a cover, wherein the retractable arm, when in the retracted position; the sensor apparatus; and the winch are collectively enclosed by the cover on at least three sides. By enclosing the components of the system within a cover, the components are protected from outside environmental conditions such as wind, rain, or sun, and protects against detritus from accumulating in and around the components. The cover may enclose the components of the system on four, five, or six sides. The cover may define an opening on a first side of the cover through which the distal portion of the retractable arm passes through in the deployed position. The cover may comprise a door to close the opening when the system is not in use. The door, either by its own actuator or due to another actuator, e.g., may be pushed open by the distal portion of the retractable arm. The cover may be composed of diverse materials such as metal, composite material, natural material, woven material, or a combination thereof. The cover may be composed of metal plates, such as steel; polymer sheets; carbon fibre covers; or plexiglass. These offer an additional layer of security and resistance against external factors. The cover may have a shape conforming to the shape of the frame. The cover may be flexible (e.g., composed of flexible sheets).

The designs of automatic sensor deployment system described herein can provide an advantageously compact system. For example, the largest dimension of the automatic sensor deployment system, when the retractable arm is in the retracted position, is no more than 6 metres, optionally no more than 5 metres, 4 metres, 3 metres, or 2 metres. 1 metre is approximately 3.3 feet. The automatic sensor deployment system, when the retractable arm is in the retracted position, may be confined to an oblong region with a volume no more than 10 cubic metres, optionally no more than 8 cubic metre, 6 cubic metres, or 4 cubic metres. 1 cubic metre is approximately 35.3 cubic feet. The oblong region may have a first dimension (e.g., height) no more than 3 metres; a second dimension (e.g., depth in a direction parallel to the retractable arm) no more than 3 metres; and a third (e.g., width in a direction perpendicular to the retractable arm) dimension no more than 1 metre.

The sensor apparatus may comprise a stand for resting on an underwater surface. The stand may comprise one leg. The stand may be collapsible, i.e. can transition from an expanded state for resting on an underwater surface to a collapsed state for storage, and vice versa. The collapsed state for storage takes up less space than the expanded state, which contributes to the automatic sensor deployment system having a smaller footprint and/or slimmer profile on a vessel, taking up less deck space. The stand may comprise a plurality of legs and the plurality of legs may be configured to open out as the sensor apparatus is lowered. The plurality of legs may be configured to close as the sensor apparatus is raised. The opening and closing of the plurality of legs may be automatic, i.e. without manual intervention. The stand may comprise one or more foot, e.g., one foot per leg, arranged to engage with the seafloor. The stand may comprise one or more rod, arranged to at least partially penetrate the seafloor. The stand may incorporate multiple legs that dynamically adapt their position during deployment and retraction, thereby ensuring the stability of the apparatus and preserving the integrity of the sensor data. The terms “configured to open out” and “configured to close” are relative and denote a movement of the legs in relation to their previous position. The legs opening out thus refers to the legs moving away from one another. The legs closing thus refers to the legs moving closer together. When closing, the legs do not need to be brought completely together. Rather, they are brought closer together than they previously were.

The sensor apparatus may comprise a bias element configured to bias the plurality of legs open. In such examples, the automatic sensor deployment system is configured to actuate the plurality of legs to close them, e.g., as part of the actuation of the retractable arm or the winch or using a stand actuator. In other examples, the bias element may be configured to bias the plurality of legs closed, and the automatic sensor deployment system is configured to actuate the plurality of legs to open them, e.g., as part of the actuation of the retractable arm or the winch or using a stand actuator. The bias element may be spring-loaded, e.g., using a spring or other tensioning member, held in tension when plurality of legs is closed and biased towards a relaxed state when the plurality of legs is open, or vice versa. In alternative arrangements, the bias element is a weight that creates a moment about a leg pivot point biasing the plurality of legs open. The legs of the plurality of legs may open and/or close independently of other legs, or collectively. The legs may be approximately 1 metre in length. The legs may be longitudinally extendable and retractable, allowing a reduced stowed size of the stand and sensor apparatus.

The automatic sensor deployment system may comprise a sensor apparatus sheath that is configured to at least partially receive the sensor apparatus, such that the sensor apparatus sheath is configured to close the plurality of legs as the sensor apparatus is pulled into the sensor apparatus sheath. This may be done by the lifting cable being threaded through the sensor apparatus sheath. In an implementation, as the sensor apparatus is retracted into the sheath, the plurality of legs of the stand are closed together due to the lateral force exerted by the sheath on the legs. The sensor apparatus sheath acts in concert with the lifting cable to guide the retraction of the sensor apparatus, automatically closing the plurality of legs as it is pulled upwards, promoting a streamlined profile to minimize potential entanglement and damage.

The retractable arm may be telescopic or have a telescopic structure, e.g., comprising concentric tubular portions configured to slide with respect to one another. The tubular portions may have a cross-sectional shape that is circular, square, rectangular, or another suitable cross-sectional shape. The retractable arm may be configured to extend in length when actuated between the retracted position and the deployed position. This provides the system with an advantage of adjustable reach, enabling the system to adapt to different spatial constraints onboard the vessel. This flexibility ensures the safety and accuracy of sensor deployment under varying operational conditions. The retractable arm being telescopic also means that the retractable arm takes up less space in the retracted position, providing an automatic sensor deployment system having a smaller footprint and/or slimmer profile on a vessel, taking up less deck space. In addition, having a telescopic retractable arm increases deck safety since the moving parts only extend overboard. In contrast, when using traditional A-frame based launch systems or using cranes on deck of the vessel, personnel safety is reduced due to moving parts on deck. Additionally, or alternatively, the retractable arm may be pivotably connected to the frame, such that it can swivel on the frame, such as adjusting the retractable arm angle with respect to a plane parallel to the ground or sea-level and provide horizontal and/or vertical movement of the distal end of the retractable arm. The retractable arm may be extendable to a maximum length of 3 metres, or to a maximum length of 1 to 4 metres, or 2 to 3 metres. Greater maximum lengths of extension can also be achieved depending on the requirements of the system, e.g., the distance between the automatic sensor deployment system position on deck and the edge of the vessel and/or how much clearance beyond the edge of the vessel is required to allow safe deployment of the sensor apparatus.

In some implementations, the telescopic retractable arm has two concentric tubular portions, a first tubular portion that is fixed to the frame and a second tubular portion configured to slide with respect to the first tubular portion. The second tubular portion may be arranged concentrically inside the first tubular portion or concentrically outside the first tubular portion. In some implementations, the telescopic retractable arm has three concentric tubular portions: a first tubular portion that is fixed to the frame; a second tubular portion configured to slide with respect to the first tubular portion; and a third tubular portion configured to slide with respect to the second tubular portion (and so also with respect to the first tubular portion). In general, the telescopic retractable arm has two or more concentric tubular portions and can be designed with a greater number of concentric tubular portions, which increases the ratio between the extended length of the retractable arm in the deployed position and the retracted length in the retracted position, although may also increase the cross-sectional size of the retractable arm.

The lifting cable may comprise a data transmission cable for carrying data from the sensor apparatus. As such, the lifting cable connecting the sensor apparatus and the winch can serve a dual purpose by also functioning as a data transmission cable. Additionally, or alternatively, the lifting cable comprises a power cable. In an implementation, the transmission cable and the power cable are integrated in the lifting cable. In an implementation, the sensor deployment system comprises separate transmission and/or power cables, which may be provided next to the lifting cable, but not forming part of the lifting cable, to provide a power supply to the sensor apparatus and data transmission capabilities from the sensor apparatus. As a result, power and real-time data transmission from the sensor apparatus is facilitated. The data may be received at a processor or sent from a communication module to a remote location. An action to raise and retract the sensor apparatus may be taken in response to the data. An action for a vessel may be taken in response to the data, e.g. if a processor determines that the underwater region is safe to therefore lower jack-up legs of a jack-up vessel. In implementations where the power and/or data transmission cables are integrated with the lifting cable, this eliminates the need for separate data cables, thereby reducing potential points of failure and complexity of the system.

The sensor apparatus may be no more than 500 kilograms, no more than 400 kilograms, no more than 300 kilograms, no more than 200 kilograms, no more than 100 kilograms, no more than 50 kilograms, no more than 25 kilograms, or no more than 10 kilograms.

The automatic sensor deployment system may comprise a washing apparatus for cleaning the sensor apparatus. The washing apparatus may comprise a washing fluid reservoir arranged to hold a washing fluid, at least one nozzle for applying the washing fluid from the washing fluid reservoir to the sensor apparatus, and at least one conduit for transporting the washing fluid from the washing fluid reservoir to the at least one nozzle. This cleaning function serves to increase the lifespan and reliability of the sensor apparatus by reducing the risk of damage from accumulated debris or biofouling. This enhancement reduces maintenance needs and promotes accurate and reliable data collection. The washing apparatus may be supported by the frame, so that the system including the washing apparatus can all be lifted by a lifting point on the frame. The at least one nozzle may be positioned and orientated to direct the washing fluid at the sensor apparatus in a stowed position. Additionally, or alternatively, the at least one nozzle may be configured to move in position or orientation to direct the washing fluid at different parts of the sensor apparatus. In an implementation, the at least one nozzle may be positioned outside of the frame, such that the sensor apparatus can be cleaned before being stowed in the frame. In such an embodiment, the at least one nozzle may be provided overboard on the side of the vessel. The at least one nozzle may be moved and/or directed by a nozzle actuator that is directly or indirectly (e.g., via another actuator) controlled by the at least one actuator. The at least one nozzle may move along a rail and therefore provide a greater area of the sensor apparatus with washing fluid. Automation of the washing apparatus reduces the need for manual intervention, which could increase operational efficiency and safety, particularly in challenging environments or during extended missions.

The washing apparatus may apply the washing fluid to the sensor apparatus by releasing the washing fluid above the sensor apparatus. Additionally, or alternatively, the washing apparatus may apply the washing fluid by pressurizing the washing fluid and forcing the washing fluid out of the at least one nozzle. The washing apparatus may comprise a pump configured to pump washing fluid through the at least one conduit and out of the at least one nozzle. The at least one actuator may be configured to control operation of the pump to cause the washing apparatus to apply washing fluid to the sensor apparatus. The at least one conduit may be piping attached to the frame connecting the washing fluid reservoir to the at least one nozzle, optionally via the pump if included. The at least one conduit may be flexible piping, e.g., plastic piping, or rigid piping, e.g., metal piping, or a combination thereof. The washing fluid may be water, e.g., potable water, and may include a detergent. An advantage of using water, such as potable water, is to avoid adding contaminants to the body of water that the vessel is in and avoiding the need for a separate drainage system to avoid run-off into the body of water. The washing fluid reservoir may be configured to receive rainwater from a rain catchment area, e.g., a roof of the frame. This allows the washing fluid to be replenished without the vessel requiring manual intervention.

In some implementations, the at least one nozzle include two nozzles, e.g., arranged on opposite sides of the sensor apparatus when in a stowed configuration, to direct the washing fluid at opposite sides of the sensor apparatus. In some implementations, the at least one nozzle may include three nozzles, e.g., pointing in three orthogonal directions. In some implementations, the at least one nozzle include four nozzles, e.g., pointing at the sensor apparatus from four sides. In some implementations, the at least one nozzle include five nozzles, e.g., pointing at the sensor apparatus from four sides and one from above. The frame may comprise a drain to allow washing fluid, after its application to the sensor apparatus, to drain away from the automatic sensor deployment system.

The automatic sensor deployment system may be releasably fastened onto a deck of a vessel. The ability to be releasably fastened onto a deck of a vessel confers an advantage of mobility and ease of installation, permitting the system to be relocated, stowed or removed for maintenance as needed. This feature enhances the flexibility of the system's application across different vessels or mission profiles. The releasable fastening may be by bolts and nuts fixed through braces on a surface of the vessel, or by ropes or cables attached between the automatic sensor deployment system and the surface of the vessel, or any suitable way of securing the system in place with sufficient strength to avoid rocking, sliding or other motion of the system, particularly when the sensor apparatus is deployed over the edge of the vessel.

The automatic sensor deployment system may further comprise a communication module for receiving an instruction signal from a remote location. The remote location may be a mother ship from which the vessel is deployed, another part of the vessel on which the system is mounted, a control centre on land, or anywhere not on the vessel. The instruction signal may comprise instructions that cause the at least one actuator to actuate the retractable arm and/or the winch. The instruction signal may comprise instructions that cause the at least one actuator to actuate any other actuator of the system, e.g., for opening a door of the frame, for operating the washing apparatus, for opening or closing a plurality of legs of the stand, etc. The inclusion of a communication module allows the system to receive instruction signals from a remote location. This allows operators to remotely control the system, which can enhance safety by reducing direct human interaction with the system, particularly in hazardous environments or weather conditions. The communication module may comprise a wireless transceiver, for receiving signals via radio waves or other frequencies of electromagnetic radiation. Additionally, or alternatively, the communication module may include a wired connection to another communication module elsewhere on the vessel. The instruction signal may include one or more of the following commands: deploy payload; recover payload to surface; recover payload to container; request winch configuration including cable length; etc.

The communication module may also be configured to send data received from the sensor to the remote location, status information about the automatic sensor deployment system or components thereof. For example, the communication module may send data describing one or more of: status of lifting cable motion; length of deployed lifting cable; current max speed of lifting cable let out or retract; extension length of retractable arm; sensor status; power unit status; maintenance status; etc. The communication may be sent in response to a request from the remote location, sent periodically, or sent in response to a prompt from a component of the automatic sensor deployment system. The communication may also be sent to another part of the vessel, e.g., to a control system of jack-up legs of a jack-up vessel indicating that the region below the jack-up vessel is clear for lowing the jack-up legs.

The automatic sensor deployment system may further comprise a processor configured to coordinate actuation of the distal portion of the retractable arm and the winch to deploy the sensor apparatus. The processor may also coordinate the actuation of any other actuator of the automatic sensor deployment system, e.g., for opening a door of the frame, for operating the washing apparatus, for opening or closing a plurality of legs of the stand, etc. The processor configured to coordinate the actuation of the retractable arm and the winch (and optionally other actuators) provides enhanced precision and synchronization during deployment of the sensor apparatus. This coordination can increase the reliability and accuracy of the sensor apparatus deployment and recovery, potentially improving the overall quality of collected data. The processor may coordinate the actuation in response to receiving an instructions signal. Additionally, or alternatively, the automatic sensor deployment system may comprise a memory containing a set of instructions for coordinating the actuators and the processor may carry out the set of instructions. The processor may also write data received from the sensor to the memory for recording until it can be retrieved and sent to a remote location, e.g., when the vessel is next in range of wireless communication.

According to another aspect of the present disclosure, there is provided a method of deploying the sensor apparatus for underwater sensing, the method using any automatic sensor deployment system as described above. The method comprises actuating the distal portion of the retractable arm from the retracted position to the deployed position; and lowering the sensor apparatus by letting out the lifting cable from the winch. The method may include actuating any other actuator of the automatic sensor deployment system, e.g., for opening a door of the frame, for operating the washing apparatus or any component thereof, for opening or closing a plurality of legs of the stand, etc., such as described in the above. The method may further comprise receiving instructions from a remote location to deploy the sensor. The actuating the distal portion of the retractable arm and the lowering the sensor may be performed automatically in response to receiving the instructions. By including an automatic response to instructions received from a remote location, remote control over the deployment process is allowed, reducing the necessity for onboard crew and increasing the safety and versatility of sensor deployment.

The method may comprise automatically opening the plurality of legs after starting to actuate the distal portion. In some implementations, the legs may be opened by letting out the lifting cable so that the sensor apparatus exits a sensor apparatus sheath, and a bias element relaxes to open the legs.

The method may comprise sensing, by the sensor while the sensor is underwater, a property of an underwater region. The property may include one or more of: a topographical map of the seafloor; an absence of identified hazard; a structural property of the seafloor; a material composition of the seafloor; etc. The method may comprise raising the sensor apparatus by retracting the lifting cable from the winch. The method may comprise retracting the distal portion of the retractable arm from the deployed position to the retracted position.

The method may comprise closing the plurality of legs after starting to raise the sensor apparatus. In some implementations, the legs may be closed by retracting the lifting cable so that part of the sensor apparatus enters a sensor apparatus sheath and to provide a force to close the legs, e.g., putting a bias element under tension.

In any implementation of the automatic sensor deployment system comprising any washing apparatus as described above, the method may comprise applying the washing fluid to the sensor apparatus to clean the sensor apparatus, according to any of the ways described above.

According to another aspect of the present disclosure, there is provided a computer-readable medium comprising instructions, that, when executed by at least one processor, cause the at least one processor to perform operations comprising any of the methods as described above. The at least one processor may include the processor of the automatic sensor deployment system as described above. The computer-readable medium may be non-transitory.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary implementations of the disclosure and are therefore not to be considered to be limiting of its scope, the principles herein are described and explained with additional specificity and detail by way of example to illustrate aspects of the disclosure and with reference to the accompanying drawings, in which:

FIG. 1 schematically illustrates an automatic sensor deployment system in use.

FIG. 2 illustrates an automatic sensor deployment system in a stowed configuration.

FIG. 3 illustrates the automatic sensor deployment system of FIG. 2 during deployment.

FIG. 4 illustrates a retractable arm, in a retracted configuration, of the automatic sensor deployment system of FIG. 2.

FIG. 5 illustrates a cross-sectional view of the retractable arm of FIG. 4 in a retracted configuration.

FIG. 6 illustrates a portion of the automatic sensor deployment system of FIG. 2.

FIG. 7 schematically illustrates a method of deploying a sensor apparatus of an automatic sensor deployment system.

FIG. 8 schematically illustrates a computer system.

In the drawings, like reference numerals donate identical parts or parts performing an identical or comparable function or operation.

### DETAILED DESCRIPTION

The following is a description of certain embodiments of the invention, given by way of example only and with reference to the drawings.

Various implementations of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. A reference to an implementation in the present disclosure can be a reference to the same implementation or any other implementation. Such references thus relate to at least one of the implementations herein.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various implementations given in this specification.

The present disclosure describes improved systems and methods for deploying a sensor from a vessel to a location on the seafloor without physical interaction from a vessel crew. The system can be executed from the vessel site or remotely via network connection from a remote location. This is particularly useful for autonomous vessels, but also has safety, space-saving, and environmental advantages for both crewed and uncrewed vessels.

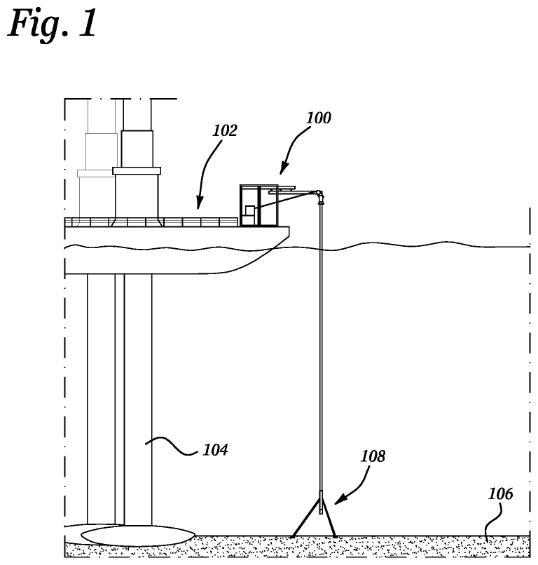

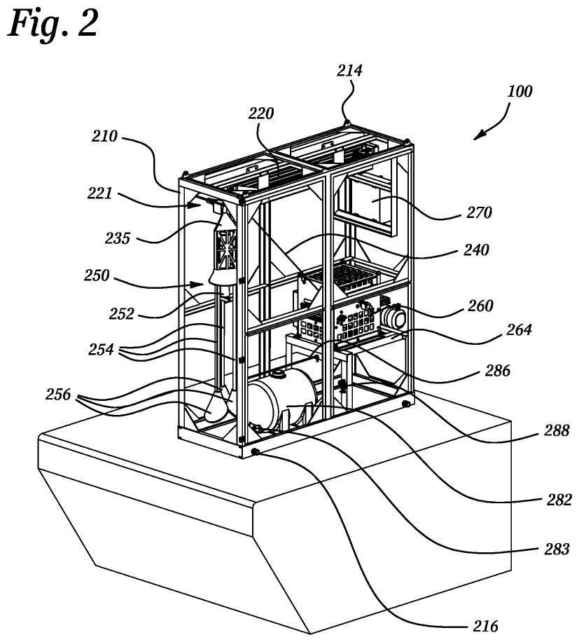

With reference to FIG. 1, as an overview of how an automatic sensor deployment system according to the present disclosure can be used, an automatic sensor deployment system 100 is welded on a deck of a jack-up vessel 102. The jack-up vessel has jack-up legs 104 on which to support the jack-up vessel 102 on the seafloor 106. The jack-up vessel 102 approaches a location where it desires to setup and, via control panel, an operator commands a sonar unit 108 (an example of a sensor apparatus 250 as explained below with reference to FIG. 2-8) to deploy from the automatic sensor deployment system 100 from its housing and pitch out over the vessel keel. The sonar unit has a range of 100 meters so can sense or image across the area where the jack-up legs 104 may be grounded. The operator instructs the automatic sensor deployment system 100 to lower the sonar unit 108 to the desired depth to record data. Once the data is recorded, the operator commands the sonar system to be recovered to the surface and a decision can be made to lower the jack-up legs 104, or reposition the jack-up vessel 102 before lowering the jack-up legs 104. Although FIG. 1 shows the sonar unit 108 descend substantially vertically, there may be a drift current that causes the sonar unit 108 to be displaced laterally and not directly below the point where it is let down from.

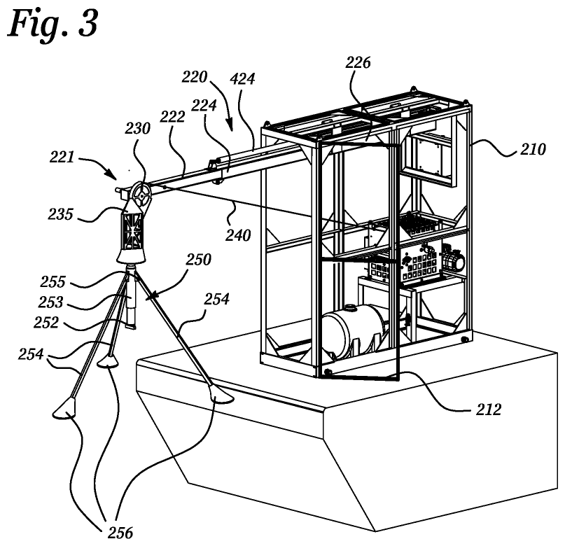

With reference to FIGS. 2 and 3, an automatic sensor deployment system 100 is mounted on a deck of a vessel. The automatic sensor deployment system 100 comprises a frame 210 that provides a structure for the automatic sensor deployment system and to which the components of the system are mounted. The frame 210 is made up of vertical and horizontal struts defining an enclosure in which the components of the automatic sensor deployment system are arranged. Around the frame 210 is mounted panelling forming a cover (not shown in FIG. 2 for visibility into the enclosure) to protect the insides of the enclosure. The side of the enclosure facing the edge of the vessel has a door 212 (not shown in FIG. 2 for visibility into the enclosure) that can be actuated to open and close the enclosure. The frame includes a lifting point 214 on each of the four top corners of the frame through which hooks or cables may pass in order to lift the entire automatic sensor deployment system 100 onto or off the deck. In alternative arrangements, there may be a single lifting point. The frame also includes a spout 216 at the bottom of the enclosure to drain away any excess water that may accumulate in the enclosure out onto the deck. In an implementation, which is not shown in the figures, the frame may comprise forklift fork tubes. In an implementation, such forklift fork tubes may be integrated with drainage holes. In such an implementation, the forklift fork tubes are arranged to receive the prongs of a forklift such that the forklift is able to lift the frame and move the system to another location.

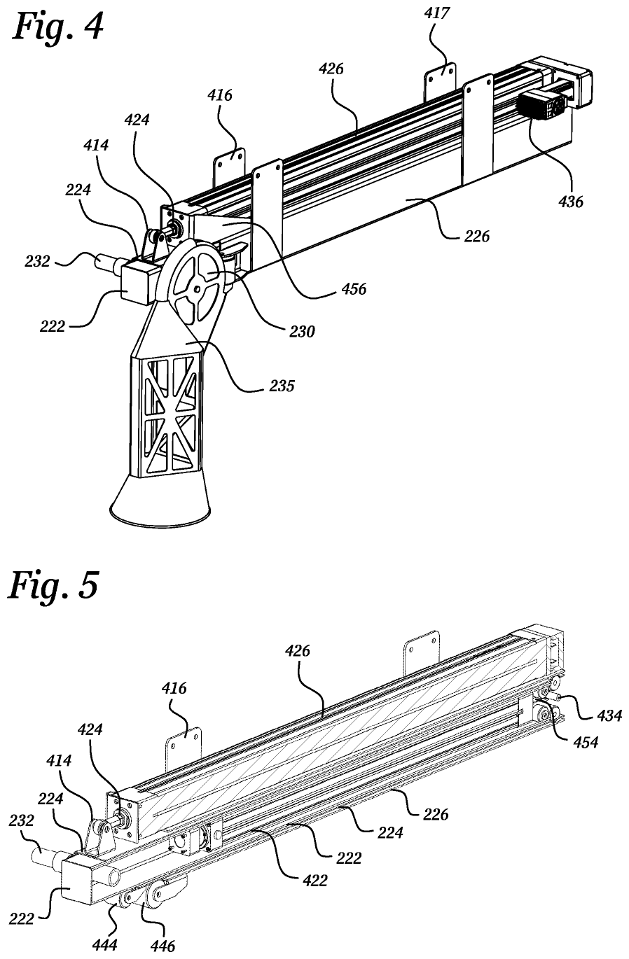

The automatic sensor deployment system 100 comprises a retractable arm 220 mounted on the frame at the top of the enclosure, as explained in more detail below with reference to FIGS. 4 and 5. The automatic sensor deployment system 100 comprises a cable guide 230 in the form of a pulley (not visible in FIG. 2 but visible in FIGS. 3 and 4). A lifting cable 240 runs from a winch 260 over the cable guide 230 and to a sensor apparatus 250, to suspend the sensor apparatus 250 from a distal end 221 of the retractable arm 220. The lifting cable 240 is a ½-inch Kevlar cable (0.5 inches is approximately 1.3 centimetres). In alternative arrangements, other sizes and materials of lifting cable may be used according to the specific implementation, e.g., the weight of the sensor apparatus 250. There is also a sensor apparatus sheath 235 for receiving the top portion of the sensor apparatus 250 and moving the sensor apparatus into a collapsed configuration.

The sensor apparatus 250 comprises a sensor 252 for underwater sensing, such as a scanning sonar unit, attached to a stand for resting on the seafloor and supporting the sensor 252 while it senses data. The stand is a tripod comprising a stand body 253 (inside the sensor apparatus sheath in FIG. 2 and visible in FIG. 3) and three legs 254, the legs each having a foot 256 at one end for resting on the seafloor. Each leg 254 is attached to the stand body 253 at a respective pivot point 255 near an end of the leg opposite to the end that rests on the seafloor. The leg 254 can rotate about the pivot point 253 between substantially parallel to the stand body 253 and at an angle to form a tripod shape with the other two legs. In some implementations, the sensor 252 is a sonar unit 108. Other types of sensors that may be used include velocity sound profilers. The size of the frame 210 and enclosure therein may determine the type of sensor that is feasible. The deployment distance overboard and the depth it reaches is dependent on the type of sensor used. The type of sensor used may also depend on the type of lifting cable used and cable thickness, etc.

The winch 260 contains a cable drum (not shown), onto which the lifting cable 240 can be spooled and unspooled, and a motor (not shown) to rotate the cable drum to controllably let out and retract the lifting cable 240. The winch 260 is electrically powered and sits on a platform 264 so that it is positioned above the deck level of the vessel to reduce the risk of encountering stray water that could cause damage. The platform is built into the frame 210 to hold it securely with respect to the other parts of the system, and so that the winch 260 can be transported as an integral part of the automatic sensor deployment system 100. In some implementations, the winch is programmable and has a dedicated electrical system, either part of or connected to the rest of electrics of the system.

The automatic sensor deployment system 100 comprises an electronics cabinet 270 to house some or all of the electrical components used in the automatic sensor deployment system 100, connected to the other components of the system to control the actuation of the moving components. The connection to other components may be wired or wireless. The electronics cabinet 270 is mounted to the frame 210. In alternative implementation, the electronic circuits may be distributed around the enclosure, such as in the winch 260 or retractable arm 220. In some implementations the electronics cabinet 270 includes a power unit such as a battery. In some implementations the actuation is controlled by one or more electronic switch (and electronic circuits to control when each switch is switched) arranged to individually turn on/off the movement of the winch 260, retractable arm 220, and/or other actuatable components. In some implementations, the system comprises a processor, such as described below with reference to FIG. 10. In other implementations, a processor is not required in the automatic sensor deployment system 100 as decision-making can be made remotely and instructions received from outside of the automatic sensor deployment system 100. As such, the actuators could be analogue, e.g., responding to variable amplitude and current in electrical signals, rather than data carried via digital signals.

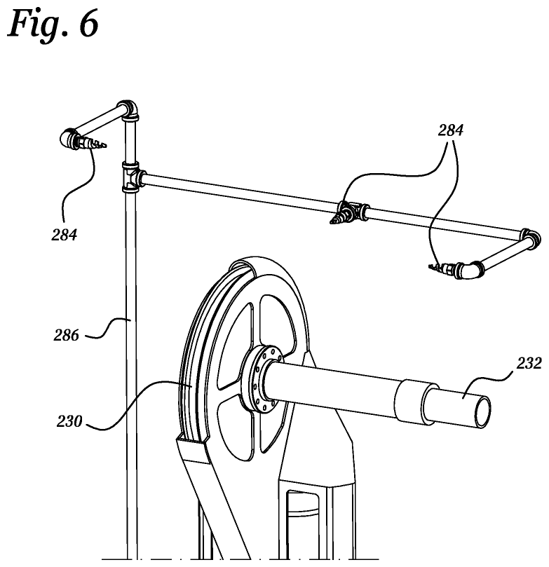

The automatic sensor deployment system 100 comprises a washing apparatus arranged to spray water at the sensor apparatus 250 after it returns from underwater deployment, e.g., to wash off salt-water, mud, seaweed, etc. Potable water is held in a washing fluid reservoir 282, filled with water via an opening on the top of the reservoir opened by unscrewing a cap. At a lower portion of the reservoir there is an outlet 283. The outlet 283 is connected to piping 286 via pump 288 by a flexible hose (not shown). In alternative arrangements the piping 286 may connect via the pump 288 all the way to the outlet 283 of the reservoir 282. The piping 286 transports water to three nozzles 284 (not visible in FIG. 2 but visible in FIG. 6) from where the water is sprayed onto the sensor apparatus 250. The nozzles 284 are fixed to the frame 210 near the top of the enclosure pointing at the sensor apparatus from different directions to wash the sensor apparatus.

FIG. 2 shows the automatic sensor deployment system 100 in a stowed configuration, i.e., with the sensor apparatus 250 stowed, the sensor apparatus legs in a collapsed configuration, and the distal portion 211 of the retractable arm in a retracted position. FIG. 3 shows the automatic sensor deployment system 100 during deployment wherein the retractable arm 220 has extended to move the distal portion 211 into a deployment position outside of the frame 210 and over the edge of the vessel, and the winch 260 has started to let out the lifting cable enough for the sensor apparatus 250 to begin to descend from the cable guide 230 and exit the sensor apparatus sheath 235. This also shows the sensor apparatus 250 in an expanded configuration, with legs 254 opened.

With reference to FIG. 3, the door 212 is open so that the distal end 221 of the retractable arm 220 can extend out of the frame 210, to move the sensor apparatus over the side of the vessel for lowering into the water. The retractable arm 220 is extended to its maximum extent. The retractable arm 220 is telescopic with three concentrically arranged tubular portions that slide with respect to each other, namely, an inner portion 222, an intermediate portion 224, and an outer portion 226, as described further below with reference to FIGS. 4 and 5. The winch 260 has let out some of the lifting cable 240 to allow the distal end 221 of the retractable arm to move to the deployed position, along with the cable guide 230 located at the distal end 221. The winch 260 has also let out enough of the lifting cable 240 for the sensor apparatus 250 attached at the end of the lifting cable 240 to drop out of the sensor apparatus sheath 235. This causes the stand legs 254 to expand outwards into an expanded configuration due to a bias element. This may be done by having a sliding weight as a bias element inside the stand body 253, possibly including the sensor 252, that pulls down an upper end of the legs, creating a moment about the pivot points 255 to open the legs 254. In other implementations, the sensor apparatus 250 has an elastic member or spring as a bias element to either push out the legs 254 at a position below the pivot points 255 or pull in the legs 254 at a position above the pivot point 255. In an implementation, the legs 254 may be expanded and/or retracted through a motorized legs actuator, such as an electrical motor. In an alternative implementation, the legs 254 may be provided with electrical rams, or hydraulic pistons to push each leg out. In such implementations, the bias element is optional as the actuation may be provided by the legs actuator. In an implementation, the system comprises a legs actuator arranged to provide extension and collapse of the legs. In such an implementation, both the sheath 235 and the bias element are optional. If the winch 260 continues to let out the lifting cable, the sensor apparatus will be lowered into the water beside the vessel.

In some an example implementation, the dimensions of the automatic sensor deployment system 100 are as follows (1 foot is approximately 0.3 metres.). Dimensions with the sensor apparatus in the stowed configuration: height approximately 3 metres (9 feet); width approximately 90 centimetres (3 feet); and depth approximately 2.4 metres (8 feet). The height may be between 1 and 6 metres; the width may be between 0.5 and 2 metres; the depth may be between 1 and 5 metres. Dimensions with the sensor apparatus in the deployed configuration: retractable arm extension approximately 2.7 metres (9 feet); stand legs approximately 90 centimetres (3 feet). The retractable arm extension may be between 1 and 6 metres; the stand legs may be between 0.5 and 2 metres.

FIG. 4 shows the retractable arm 220, with the distal portion 211 in a retracted position, in isolation from the frame 210 and other components of the automatic sensor deployment system 100. The inner portion 222, at or near the front of the retractable arm 220, i.e., the part forming the distal portion of the retractable arm, has an axel 232 positioned through the inner portion 222 allowing rotation of the cable guide 230. The outer portion 226 is fixed to the frame 210 by a pair of brackets 416 fastened to the frame 210 by screws (or any suitable fastening techniques) at a position towards the front of the outer portion 226 (i.e. the end nearer to the edge of the vessel) and a pair of brackets 417 at a position towards the rear of the outer portion 226 (i.e. the end further from the edge of the vessel). In other implementations, the retractable arm 220 may be attached to the frame with fewer or different brackets or other fastenings, welding, etc. On top of the outer portion 226 of the retractable arm 220 sits a first arm actuator 426, namely, an electric rod actuator, driven by an actuator motor 436. The first arm actuator 426 is arranged to extend and retract the intermediate portion 224 out of and into the outer portion 226. The first arm actuator is fixed to the outer portion by a brace 456 and, when actuated, pushes a first actuator rod 424 out of an internal region of the first arm actuator and through the brace 456. The first actuator rod 424 is connected to the intermediate portion 224 via a connector 414 that is either part of or fixed to the intermediate portion 224. Accordingly, as the first actuator rod 424 is actuated, it causes the intermediate portion 224 to slide out of the outer portion 226, to a position as shown in FIG. 3. As shown in FIG. 5, the outer portion comprises rollers 446 to facilitate the intermediate portion 224 sliding out of the outer portion 226.

FIG. 3 shows the retractable arm 220, in a deployed configuration. In FIG. 5, a side of the inner portion 222, intermediate portion 224, and outer portion 226 is not shown to illustrate the mechanism inside the inner portion 222. Inside the inner portion 222 sits a second arm actuator 422, namely, an electric rod actuator, driven by an actuator motor (either the same actuator motor as drives the first arm actuator or a different motor). The second arm actuator 422 is arranged to extend and retract the inner portion 222 out of and into the intermediate portion 224. The second arm actuator 422 is fixed to the inner portion 222 by a brace (not shown) and, when actuated, pushes a second actuator rod 454 out of an internal region of the second arm actuator 422. The second actuator rod 454 is connected to the intermediate portion 224 via a pin 434 that is either part of or fixed to the intermediate portion 224. Accordingly, as the second actuator rod 454 is actuated, it pushes away on the intermediate portion 224 and causes the inner portion 222 to slide out of the intermediate portion 224, to a position as shown in FIG. 3. The intermediate portion 224 comprises rollers 444 to facilitate the inner portion 222 sliding out of the intermediate portion 224.

With reference to FIG. 6 the nozzles 284 of the washing apparatus, as described above with reference to FIG. 2, are spiral nozzles arranged above or near the top of the sensor apparatus 250. One nozzle is arranged at the front of the automatic sensor deployment system 100, i.e. the side nearest the edge of the vessel, and faces backwards towards the sensor apparatus 250. Two other nozzles are positioned on either side of the sensor apparatus 250 facing inwards. This provides spray coverage from multiple angles to increase the washing thoroughness or speed.

In other implementations, there may be a different number of nozzles and alternative shapes or arrangements of nozzles may be used. In some implementations, the nozzles are moveable, e.g., able to move up and down the height of the sensor apparatus 250 while spraying water. In some implementations, the washing apparatus is jet washer with a single nozzle.

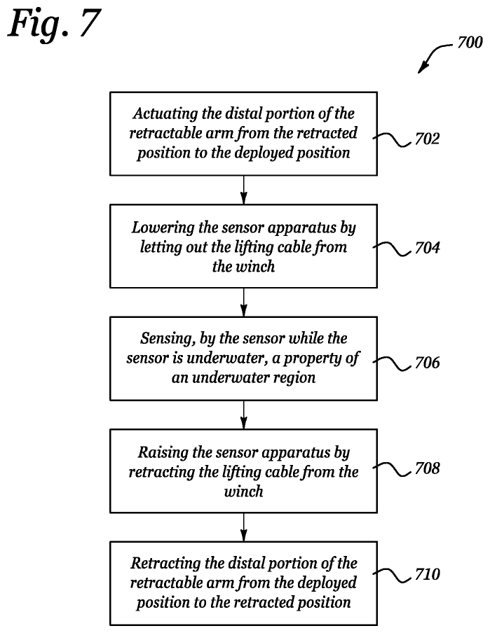

With reference to FIG. 7, a method 700 of deploying the sensor apparatus for underwater sensing using the automatic sensor deployment system 100 comprises actuating 702 the distal portion 211 of the retractable arm from the retracted position to the deployed position, i.e., by extending the retractable arm 220. The method comprises lowering 704 the sensor apparatus 250 by letting out the lifting cable 240 from the winch 260. The lifting cable runs through the cable guide 230, which rotates on the axel 232. As described above, this may automatically change the sensor apparatus 250 from a collapsed configuration for storage within the frame 210 to an expanded configuration for deployment. The sensor 252 senses 706 a property of the underwater region while underwater and sends the sensed data back through a data cable to the winch and/or a processor and/or other electrical parts. Once sensing is complete, the winch 260 retracts the lifting cable 240, pulling the lifting cable back through the cable guide 230 and thereby raising 708 the sensor apparatus 250. This is a reverse operation of the lowering 704 and in general can comprise any of the stages of the lowering 704 but in reverse. Once the sensor apparatus 250 is raised enough to clear the edge of the vessel, the distal portion 211 of the retractable arm is moved back to the retracted position, by reversing the first actuator rod 424 and second actuator rod 454 into the first arm actuator 426 and second arm actuator 422, respectively, and so sliding the inner portion 222 into the intermediate portion 224 and both the inner portion and intermediate portion 224 into the outer portion 226. Accordingly, the retractable arm 220 returns to its retracted configuration.

After returning the sensor apparatus 250 to the enclosure of the frame 210, and closing the door 212, a washing program proceeds. The washing program may be automated or initiated by a controller. An example washing program includes a combination of pre-rinsing, soaking, and rinsing. The processor or other electronic components may determine the length of each stage of the washing program according to how long the sensor apparatus 250 spent underwater, how deep it went, or water conditions.

In alternative implementations, the method 700 may only comprise the actuating 702 and lowering 704.

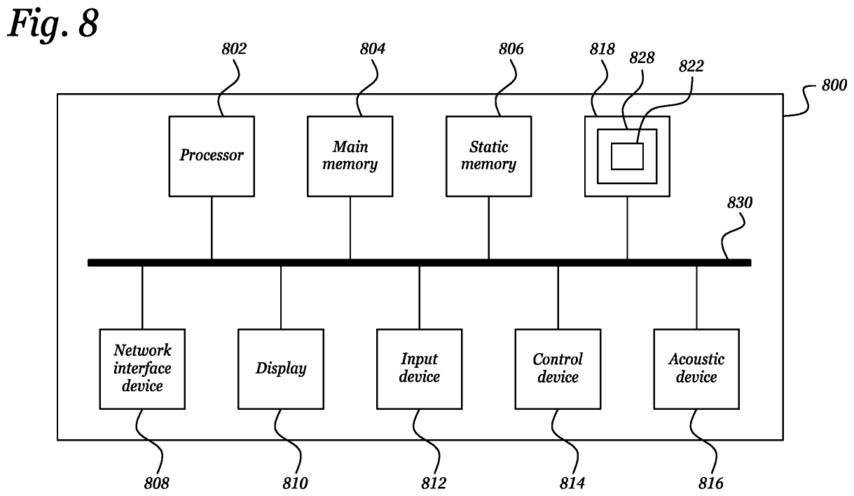

With reference now to FIG. 8, in some implementations the electrical components as described herein comprises a computing device suitable for carrying out the methods described above. In other words, the computing device controls and coordinates some or all the components of the automatic sensor deployment system 100.

FIG. 8 shows a block diagram of one implementation of a processing system 800 in the form of a computing device within which a set of instructions for causing the computing device to perform any one or more of the methods discussed herein, may be executed. In alternative implementations, the computing device may be connected (e.g., networked) to other machines in a Local Area Network (LAN), an intranet, an extranet, or the Internet. The computing device may operate in the capacity of a server or a client machine in a client-server network environment, or as a peer machine in a peer-to-peer (or distributed) network environment. The computing device may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single computing device is illustrated, the term “computing device” shall also be taken to include any collection of machines (e.g., computers) that individually or jointly execute a set (or multiple sets) of instructions to perform any one or more of the methodologies discussed herein.

The example processing system 800 includes a processor 802, a main memory 804 (e.g., read-only memory (ROM), flash memory, dynamic random access memory (DRAM) such as synchronous DRAM (SDRAM) or Rambus DRAM (RDRAM), etc.), a static memory 806 (e.g., flash memory, static random access memory (SRAM), etc.), and a secondary memory (e.g., a data storage device 818), which communicate with each other via a bus 830.

Processor 802 represents one or more general-purpose processors such as a microprocessor, central processing unit, or the like. More particularly, the processor 802 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 802 may also be one or more special-purpose processors such as an application specific integrated circuit (ASIC), a field programmable gate array (FPGA), a digital signal processor (DSP), network processor, or the like. Processor 802 is configured to execute the processing logic (instructions 822) for performing the operations and steps discussed herein.

The processing system 800 may further include a network interface device 808, e.g., a communication module. The processing system 800 also may include a video display unit 810 (e.g., a liquid crystal display (LCD) or a cathode ray tube (CRT)), an alphanumeric input device 812 (e.g., a keyboard or touchscreen), a cursor control device 814 (e.g., a mouse or touchscreen), and an audio device 816 (e.g., a speaker).

It will be apparent that some features of the processing system 800 shown in FIG. 8 may be absent. For example, the processing system 800 may have no need for display device 810 (or any associated adapters). This may be the case, for example, for particular server-side computer apparatuses which are used only for their processing capabilities and do not need to display information to users. Similarly, user input device 812 may not be required. In its simplest form, processing system 800 comprises processor 802 and main memory 804.

The data storage device 818 may include one or more machine-readable storage media (or more specifically one or more non-transitory computer-readable storage media) 828 on which is stored one or more sets of instructions 822 embodying any one or more of the methods or functions described herein. The instructions 822 may also reside, completely or at least partially, within the main memory 804 and/or within the processor 802 during execution thereof by the processing system 800, the main memory 804 and the processor 802 also constituting computer-readable storage media 828.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid-state memory, magnetic tape, a removable computer diskette, a random access memory (RAM), a read-only memory (ROM), a rigid magnetic disc, and an optical disk, such as a CD-ROM, CD-R/W or DVD.

The computer program is executable by the processor 802 to perform functions of the systems and methods described herein.

In an implementation, the modules, components, and other features described herein can be implement-ed as discrete components or integrated in the functionality of hardware components such as ASICS, FPGAs, DSPs, or similar devices.

A “hardware component” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” should be understood to encompass a tangible entity that may be physically constructed, permanently configured (e.g., hardwired), or temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

Unless specifically stated otherwise, as apparent from the following discussion, it is appreciated that throughout the description, discussions utilizing terms such as “receiving”, “determining”, “comparing”, “enabling”, “calculating”, “identifying”, “analysing”, “estimating”, “providing” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It is to be understood that the above description is intended to be illustrative, and not restrictive. Many other implementations will be apparent to those of skill in the art upon reading and understanding the above description. Although the present disclosure has been described with reference to specific example implementations, it will be recognized that the disclosure is not limited to the implementations described but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

While at least one exemplary embodiment has been presented in the foregoing detailed description, it should be appreciated that a vast number of variations exist, only some of which have been mentioned above. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the appended claims and the legal equivalents thereof.

Aspects and features of the present disclosure are set forth in the following numbered clauses.

Aspect 1: An automatic sensor deployment system for automatically deploying a sensor from a vessel to an underwater position, the automatic sensor deployment system comprising:
a frame;
a retractable arm supported by the frame, wherein a distal portion of the retractable arm is configured to be actuated from a retracted position to a deployed position in a direction away from the frame;
a cable guide located at the distal portion of the retractable arm;
a lifting cable supported by the cable guide;
a sensor apparatus attached to the lifting cable, the sensor apparatus comprising a sensor for underwater sensing;
a winch configured to retract and let out the lifting cable to raise and lower the sensor apparatus; and
at least one actuator configured to actuate the retractable arm and the winch.

Aspect 2: The automatic sensor deployment system according to clause 1, wherein the winch and the at least one actuator are supported by the frame such that the automatic sensor deployment system can be lifted as a unit via the frame.

Aspect 3: The automatic sensor deployment system according to clause 1 or 2, wherein the sensor deployment system is no more than 1000 kilograms, optionally no more than 750 kilograms, 500 kilograms; 250 kilograms, or 100 kilograms.

Aspect 4: The automatic sensor deployment system according to any preceding clause, wherein the frame comprises a cover, wherein the retractable arm in the retracted position, the sensor apparatus, and the winch are collectively enclosed by the cover on at least three sides.

Aspect 5: The automatic sensor deployment system according to any preceding clause, wherein the largest dimension of the automatic sensor deployment system, when the retractable arm is in the retracted position, is no more than 6 metres, optionally no more than 5 metres, 4 metres, 3 metres, or 2 metres.

Aspect 6: The automatic sensor deployment system according to any preceding clause, wherein the automatic sensor deployment system, when the retractable arm is in the retracted position, is confined to an oblong region with a volume no more than 10 cubic metres, optionally no more than 8 cubic metre, 6 cubic metres, or 4 cubic metres.

Aspect 7: The automatic sensor deployment system according to any preceding clause, wherein the automatic sensor deployment system, when the retractable arm is in the retracted position, is confined to an oblong region having:
a first dimension no more than 3 metres;
a second dimension no more than 3 metres; and
a third dimension no more than 1 metre.

Aspect 8: The automatic sensor deployment system according to any preceding clause, wherein the sensor apparatus comprises a stand for resting on an underwater surface, wherein the stand is collapsible.

Aspect 9: The automatic sensor deployment system according to clause 8, wherein the stand comprises a plurality of legs, wherein the plurality of legs is configured to open out as the sensor apparatus is lowered and to close as the sensor apparatus is raised, and wherein the sensor apparatus comprises a bias element configured to bias the plurality of legs open.

Aspect 10: The automatic sensor deployment system according to clause 9, wherein the bias element is spring-loaded.

Aspect 11: The automatic sensor deployment system according to any of clauses 8-10, wherein the automatic sensor deployment system comprises a sensor apparatus sheath, the sensor apparatus sheath being configured to receive at least part of the sensor apparatus, wherein the lifting cable is threaded through the sensor apparatus sheath, wherein the sensor apparatus sheath is configured to close the plurality of legs as the sensor apparatus is pulled into the sensor apparatus sheath.

Aspect 12: The automatic sensor deployment system according to any preceding clause, wherein the retractable arm is telescopic, wherein the retractable arm is configured to extend in length when actuated between the retracted position and the deployed position.

Aspect 13: The automatic sensor deployment system according to any preceding clause, wherein the lifting cable comprises data transmission cable for transmitting data from the sensor apparatus.

Aspect 14: The automatic sensor deployment system according to any preceding clause, wherein the sensor apparatus is no more than 500 kilograms, optionally no more than 400 kilograms, 300 kilograms, 200 kilograms, 100 kilograms, 50 kilograms, 25 kilograms, or 10 kilograms.

Aspect 15: The automatic sensor deployment system according to any preceding clause, further comprising a washing apparatus for cleaning the sensor apparatus, the washing apparatus comprising:
a washing fluid reservoir arranged to hold a washing fluid;
at least one nozzle for applying the washing fluid from the washing fluid reservoir to the sensor apparatus; and
at least one conduit for transporting the washing fluid from the washing fluid reservoir to the at least one nozzle.

Aspect 16: The automatic sensor deployment system according to clause 15, wherein the washing apparatus is supported by the frame, wherein the at least one nozzle is positioned and orientated to direct the washing fluid at the sensor apparatus.

Aspect 17: The automatic sensor deployment system according to clause 15 or 16, wherein the washing apparatus comprises a pump configured to pump washing fluid through the at least one conduit and out of the at least one nozzle, wherein the at least one actuator is configured to control operation of the pump to cause the washing apparatus to apply washing fluid to the sensor apparatus.

Aspect 18: The automatic sensor deployment system according to any preceding clause, wherein the automatic sensor deployment system is releasably fastened onto a deck of a vessel.

Aspect 19: The automatic sensor deployment system according to any preceding clause, further comprising: a communication module for receiving an instruction signal from a remote location, wherein the instruction signal comprises instructions that cause the at least one actuator to actuate the retractable arm and/or the winch.

Aspect 20: The automatic sensor deployment system according to any preceding clause, further comprising: a processor configured to coordinate actuation of the distal portion of the retractable arm and the winch to deploy the sensor apparatus.

Aspect 21: A method of deploying the sensor apparatus for underwater sensing, the method using an automatic sensor deployment system according to any preceding clause, the method comprising:
actuating the distal portion of the retractable arm from the retracted position to the deployed position; and
lowering the sensor apparatus by letting out the lifting cable from the winch.

Aspect 22: The method according to clause 21, further comprising:
receiving instructions from a remote location to deploy the sensor, wherein the actuating the distal portion of the retractable arm and the lowing the sensor are performed automatically in response to receiving the instructions.

Aspect 23: The method according to clause 21 or 22, wherein the sensor apparatus comprises a stand for resting on an underwater surface, wherein the stand is collapsible, the method comprising:
automatically opening the plurality of legs after starting to actuate the distal portion; and/or
closing the plurality of legs after starting to raise the sensor apparatus.

Aspect 24: The method according to any of clauses 21 to 23, comprising:
sensing, by the sensor while the sensor is underwater, a property of an underwater region;
raising the sensor apparatus by retracting the lifting cable to the winch; and
retracting the distal portion of the retractable arm from the deployed position to the retracted position.

Aspect 25: The method according to any of clauses 21-24, using an automatic sensor deployment system comprising a washing apparatus for cleaning the sensor apparatus, the washing apparatus comprising:
a washing fluid reservoir arranged to hold a washing fluid;
at least one nozzle for applying the washing fluid from the washing fluid reservoir to the sensor apparatus; and
at least one conduit for transporting the washing fluid from the washing fluid reservoir to the at least one nozzle,
   the method comprising:
applying the washing fluid to the sensor apparatus to clean the sensor apparatus.

Aspect 26: A computer-readable medium comprising instructions, that, when executed by at least one processor, cause the at least one processor to perform operations comprising the method of any of clauses 21-25.

1. An automatic sensor deployment system for automatically deploying a sensor from a vessel to an underwater position, the automatic sensor deployment system comprising:
a frame;
a retractable arm supported by the frame, wherein a distal portion of the retractable arm is configured to be actuated from a retracted position to a deployed position in a direction away from the frame;
a cable guide located at the distal portion of the retractable arm;
a lifting cable supported by the cable guide;
a sensor apparatus attached to the lifting cable, the sensor apparatus comprising a sensor for underwater sensing;
a winch configured to retract and let out the lifting cable to raise and lower the sensor apparatus; and
at least one actuator configured to actuate the retractable arm and the winch.

2. The automatic sensor deployment system according to claim 1, wherein the winch and the at least one actuator are supported by the frame such that the automatic sensor deployment system can be lifted as a unit via the frame.

3. The automatic sensor deployment system according to claim 1, wherein the sensor deployment system is no more than 1000 kilograms.

4. The automatic sensor deployment system according to claim 1, wherein the frame comprises a cover, wherein the retractable arm in the retracted position, the sensor apparatus, and the winch are collectively enclosed by the cover on at least three sides.

5. The automatic sensor deployment system according to claim 1, wherein the sensor apparatus comprises a stand for resting on an underwater surface, wherein the stand is collapsible.

6. The automatic sensor deployment system according to claim 5, wherein the stand comprises a plurality of legs, wherein the plurality of legs is configured to open out as the sensor apparatus is lowered and to close as the sensor apparatus is raised, and wherein the sensor apparatus comprises a bias element configured to bias the plurality of legs open.

7. The automatic sensor deployment system according to claim 6, wherein the bias element is spring-loaded.

8. The automatic sensor deployment system according to claim 6, wherein the automatic sensor deployment system comprises a sensor apparatus sheath, the sensor apparatus sheath being configured to receive at least part of the sensor apparatus, wherein the lifting cable is threaded through the sensor apparatus sheath, wherein the sensor apparatus sheath is configured to close the plurality of legs as the sensor apparatus is pulled into the sensor apparatus sheath.

9. The automatic sensor deployment system according to claim 1, wherein the retractable arm is telescopic, wherein the retractable arm is configured to extend in length when actuated between the retracted position and the deployed position.

10. The automatic sensor deployment system according to claim 1, wherein the lifting cable comprises data transmission cable for transmitting data from the sensor apparatus.

11. The automatic sensor deployment system according to claim 1, further comprising a washing apparatus for cleaning the sensor apparatus, the washing apparatus comprising:
a washing fluid reservoir arranged to hold a washing fluid;
at least one nozzle for applying the washing fluid from the washing fluid reservoir to the sensor apparatus; and
at least one conduit for transporting the washing fluid from the washing fluid reservoir to the at least one nozzle.

12. The automatic sensor deployment system according to claim 1, further comprising:
a communication module for receiving an instruction signal from a remote location, wherein the instruction signal comprises instructions that cause the at least one actuator to actuate the retractable arm and/or the winch.

13. The automatic sensor deployment system according to claim 1, further comprising:
a processor configured to coordinate actuation of the distal portion of the retractable arm and the winch to deploy the sensor apparatus.

14. The automatic sensor deployment system according to claim 1, wherein the automatic sensor deployment system is releasably fastened onto a deck of a vessel.

15. A method of deploying the sensor apparatus for underwater sensing, the method using an automatic sensor deployment system according to any preceding claim, the method comprising:
actuating the distal portion of the retractable arm from the retracted position to the deployed position; and
lowering the sensor apparatus by letting out the lifting cable from the winch.

16. The method according to claim 15, further comprising:
receiving instructions from a remote location to deploy the sensor, wherein the actuating the distal portion of the retractable arm and the lowing the sensor are performed automatically in response to receiving the instructions.

17. The method according to claim 15, wherein the sensor apparatus comprises a stand for resting on an underwater surface, wherein the stand is collapsible, the method comprising:
automatically opening the plurality of legs after starting to actuate the distal portion; and/or
closing the plurality of legs after starting to raise the sensor apparatus.

18. The method according to claim 15, comprising:
sensing, by the sensor while the sensor is underwater, a property of an underwater region;
raising the sensor apparatus by retracting the lifting cable to the winch; and
retracting the distal portion of the retractable arm from the deployed position to the retracted position.

19. The method according to claim 15, using an automatic sensor deployment system comprising a washing apparatus for cleaning the sensor apparatus, the washing apparatus comprising:
a washing fluid reservoir arranged to hold a washing fluid;
at least one nozzle for applying the washing fluid from the washing fluid reservoir to the sensor apparatus; and
at least one conduit for transporting the washing fluid from the washing fluid reservoir to the at least one nozzle,
the method comprising:
applying the washing fluid to the sensor apparatus to clean the sensor apparatus.

20. A computer-readable medium comprising instructions, that, when executed by at least one processor, cause the at least one processor to perform operations comprising the method of claim 15.
